(19) United States
(12) Patent Application Publication
(10) Pub. No.: US 2022/0152810 A1
(43) Pub. Date: May 19, 2022

(54) WORKPIECE SECUREMENT SYSTEMS

(71) Applicant: Rogue Fabrication, LLC, Sandy, OR (US)

(72) Inventor: Joseph Gambino, Sandy, OR (US)

(21) Appl. No.: 16/951,250

(22) Filed: Nov. 18, 2020

(51) Int. Cl. B25H 1/02

(52) U.S. Cl. CPC B25H 1/02

(57) ABSTRACT

Workpiece securement systems for securing a workpiece in a desired position with a clamp. The workpiece securement systems include a worktable, an anchor, a shelf, and a block. A tabletop of the worktable defines a plurality of shaped openings. The anchor is disposed in a selected shaped opening and is configured to engage a bolt. The shelf is configured to support the anchor from below the tabletop in a position where the anchor extends through the selected shaped opening. The block is supported on the tabletop and selectively couples with the anchor. The block defines a mount bore and a clamp receiver bore. The bolt passing through the mount bore and engaging with the anchor secures the position of the block on the tabletop. The clamp receiver bore is configured to receive the clamp to fix the position of the workpiece.

### BACKGROUND

The present disclosure relates generally to workpiece securement systems. In particular, workpiece securement systems in the form of work tables are described.

Known workpiece securement systems are not entirely satisfactory for the range of applications in which they are employed. For example, existing workpiece securement systems typically have tabletops with round holes defining threaded ports for mounting blocks and clamps to the table. Round holes with threaded ports suffer from a number of drawbacks. For example, round threaded ports are difficult to repair, inaccurate, and unergonomic. Weld splatter is prone to stick to the threads in the ports and render the threads inoperable and/or require maintenance to address the corrupted threads. The round holes do not adequately resist rotational movement of hardware used to secure parts in position, which limits how accurately parts can be clamped in position.

Another limitation of conventional steel tables that are used to secure parts is that they rely on threaded studs and bolts to secure pieces to the table. Threaded studs and bolts are tedious to use because of all the twisting they require to secure them. Threaded studs and bolts tend to be less accurate than desirable because the significant torque needed to secure them tends to move the block, clamp, and/or piece being secured by them.

Conventional flat tables configured to mount parts for welding are labor and time intensive to use. One reason existing tables are labor and time intensive is because all the threaded fasteners take time and effort to use. Further, significant time and labor is necessary to repair known tables when weld splatters onto threaded ports. The tendency for conventional tables to not hold parts in position accurately requires more time and labor to readjust the position of the parts and/or to redo or repair an inaccurate weld resulting from the inaccurate position in which the part was secured.

Existing welding tables are a fixed size and unitary, which limits their applicability and increases costs for the end user. It is common for a machine shop to require larger welding tables over time as they receive requests to work on larger parts. A fixed size welding table limits the size of part that machine shops can handle. The fixed size of conventional weld tables forces machine shops to replace the tables outright with new, larger tables when larger tables are needed, which is a significant expense and wasteful. Further, shipping large, fixed size, unitary weld tables is cumbersome and expensive.

Another drawback of conventional weld tables is that they do not incorporate power supplies to conveniently power lights and tools. When working on a weld table, a user often uses power tools and needs good lighting to work accurately. With existing tables, the user must position the table close to a power supply or use extension cords to bring power near the table. Neither scenario is ideal as the former limits where the table may be positioned and the latter creates clutter and trip hazards.

Thus, there exists a need for workpiece securement systems that improve upon and advance the design of known workpiece securement systems. Examples of new and useful workpiece securement systems relevant to the needs existing in the field are discussed below.

United States patent filings with disclosure relevant to workpiece securement systems include U.S. Pat. Nos. 10,556,326, 7,753,350, 7,284,406, 6,439,561, 6,364,302, 5,931,726, 5,509,214, 5,421,566, 5,249,818, 5,040,716, and 4,645,391. The complete disclosures of these listed U.S. patent filings are herein incorporated by reference for all purposes.

### SUMMARY

The present disclosure is directed to workpiece securement systems for securing a workpiece in a desired position with a clamp. The workpiece securement systems include a worktable, an anchor, a shelf, and a block. The worktable includes a leg and a tabletop. The leg supports the worktable from the ground.

The tabletop is supported by the leg and includes a top surface facing away from the ground and a bottom surface facing the ground. The tabletop defines a plurality of shaped openings extending through the tabletop from the top surface to the bottom surface.

The anchor is disposed in a selected shaped opening of the plurality of shaped openings and is configured to threadingly engage a bolt. The shelf is configured to selectively couple to the tabletop in a desired position and to support the anchor from below the bottom surface of the tabletop in a position where the anchor extends through the selected shaped opening.

The block is supported on the top surface of the tabletop and secured in a selected position on the tabletop by selectively coupling with the anchor. The block defines a mount bore and a clamp receiver bore. The mount bore extends through the block and is aligned with the anchor.

The bolt passing through the mount bore and threadingly engaging with the anchor secures the position of the block on the top surface of the tabletop. The clamp receiver bore is configured to receive the clamp to fix the position of the workpiece.

In some examples, the workpiece securement system includes a shim. In selected examples, the workpiece securement system includes a bin. In selected examples, the workpiece securement system includes an electrical system. In some examples, the workpiece securement system includes an illumination device.

### BRIEF DESCRIPTION OF THE DRAWINGS

FIG. 1 is a perspective view of a workpiece securement system securing a workpiece on a tabletop with a clamp coupled to a block secured to the tabletop.

FIG. 2 is a bottom perspective view of the workpiece securement system shown in FIG. 1.

FIG. 3 is a top plan view of the workpiece securement system shown in FIG. 1.

FIG. 4 is a front elevation view of the workpiece securement system shown in FIG. 1.

FIG. 5 is a left side elevation view of the workpiece securement system shown in FIG. 1.

FIG. 6 is a bottom view of the workpiece securement system shown in FIG. 1.

FIG. 7 is a close-up view through a tabletop depicting a shelf extending through two openings of the tabletop to support an anchor below a block and a shim mounted to the block.

FIG. 8 is a close-up view through a tabletop of two different shelf examples positioned below openings in the tabletop.

FIG. 9 is a close-up view of the underside of the workpiece securement system shown in FIG. 1 depicting a spacer between a first tabletop and a second tabletop secured in place by a boundary anchor.

FIG. 10 is a top perspective view of a second example of a workplace securement system including four tabletops, a bin, an electrical system, and a light.

### DETAILED DESCRIPTION

The disclosed workpiece securement systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various workpiece securement systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

Workpiece Securement Systems

With reference to the figures, workpiece securement systems will now be described. The workpiece securement systems discussed herein function to secure workpieces in a desired position and orientation for welding and other operations in a fast, ergonomic, and accurate way.

The reader will appreciate from the figures and description below that the presently disclosed workpiece securement systems address many of the shortcomings of conventional workpiece securement systems. For example, the workpiece securement systems described herein do not rely on round holes defining threaded ports for mounting blocks and clamps to the table, but instead use shaped openings. The shaped openings are easier to repair, more accurate, and more ergonomic than round holes in conventional weld tables. Weld splatter is much less of a hazard with the workplace securement systems described below. The shaped openings better resist rotational movement of hardware used to secure parts in position, which allows the user to more accurately secure parts in position.

The workpiece securement systems below improve over conventional weld tables by not relying merely on threaded studs and bolts to secure pieces to the table. The systems below avoid the tedium associated with twisting a large number of threaded studs and bolts. By providing an alternative to threaded studs and bolts, the systems below are more accurate because the user does not need to apply significant torque to secure the pieces into place, which would tend to undesirably move the piece being secured.

The workpiece securement systems described herein are less labor and time intensive to use than conventional systems. Reduced time and labor is necessary with the systems below because they avoid the threaded fasteners of conventional systems. Significant time and labor is saved with the systems below by avoiding the need to repair threaded ports when weld splatters onto them as regularly occurs with conventional systems. Another source of time and labor savings results from holding parts in position more accurately and with less attention and effort required. The more accurate positioning of the parts with the systems below enables the user to more accurately and consistently weld parts without errors needing corrections.

Another improvement over existing welding tables is the modular nature of the systems below. By allowing the user to readily expand the size of the system without discarding the existing system, the systems below are more flexible and reduce costs for the end user. Not needing to replace the system outright when larger systems are needed is a significant cost saver and reduces waste. Shipping the modular systems below is more convenient and less expensive as well.

The systems described below incorporate electrically isolated power supplies to conveniently power lights and tools. With the systems below, the user can more flexibly position the system and reduce clutter and trip hazards.

Workpiece Securement System

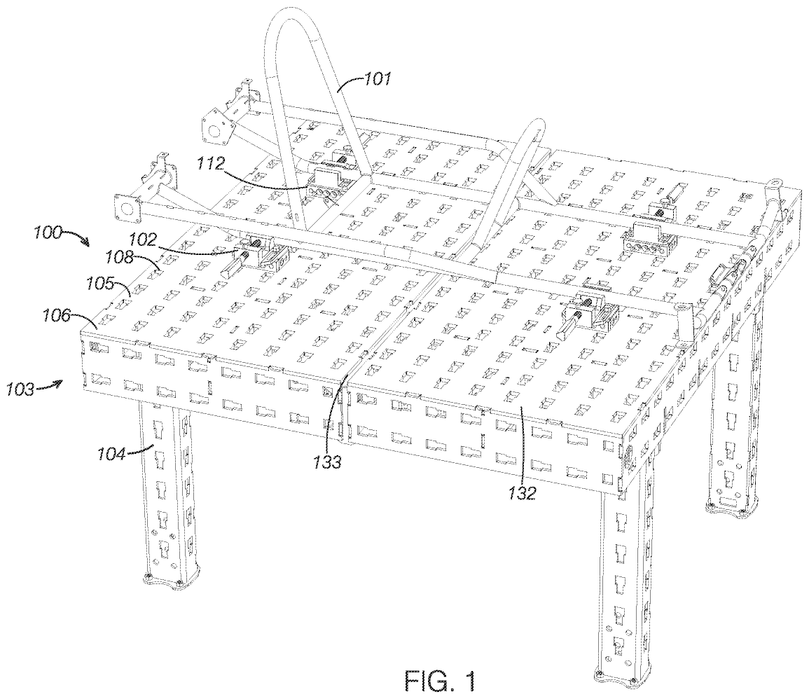

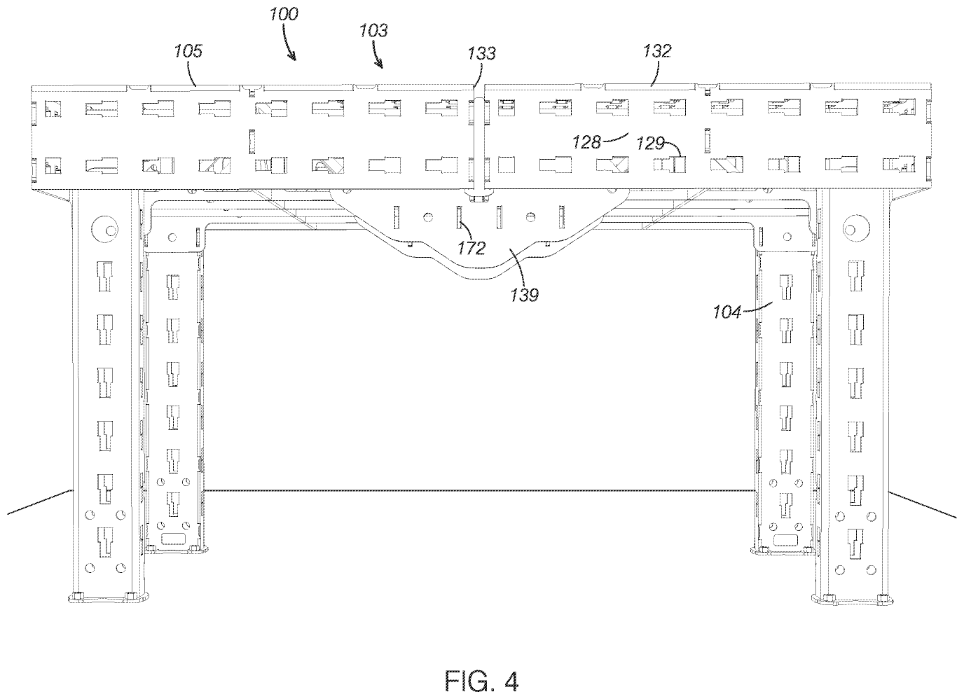

With reference to FIGS. 1-9, a workpiece securement system 100 will now be described as a first example of a workpiece securement system. As shown in FIG. 1, workpiece securement system 100 functions to secure a workpiece 101 in a desired position with a clamp 102.

As depicted in FIGS. 1-9, workpiece securement system 100 includes a worktable 103, an anchor 109, a shelf 111, a block 112, and a shim 120. In other examples, the workpiece securement system includes fewer components than depicted in the figures, such as not including a block or a shim. In certain examples, the workpiece securement system includes additional or alternative components than depicted in the figures, such as a bin, an electrical system, and an illumination device.

Worktable

Worktable 103 functions to provide a worksurface for working on workpieces. More particularly, worktable 103 cooperates with other components of system 100 to secure workpieces in desired positions.

As depicted in FIGS. 1-8, worktable 103 includes a leg 104 a tabletop 105, a second tabletop 132, a skirt 128, a spacer 136, a boundary anchor 138, and a bridge bracket 139. Other worktable examples include fewer and additional components.

For example, some worktable examples do not include a second tabletop, a skirt, a spacer, a boundary anchor, or a bridge bracket. Examples with a single tabletop may be considered a single modular unit of the workpiece securement system.

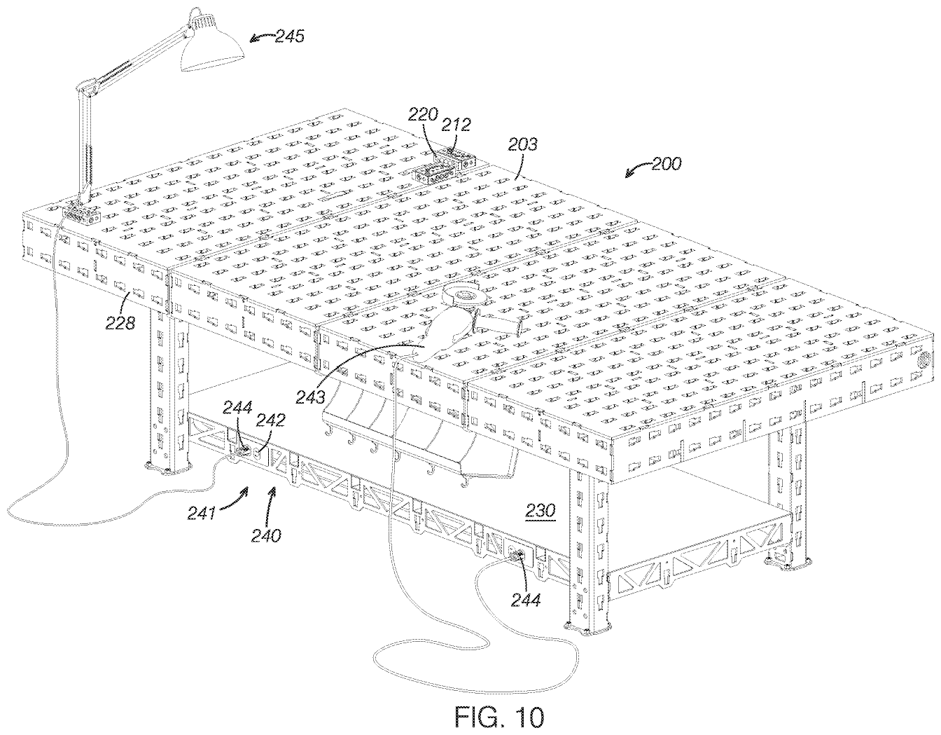

As shown in FIG. 10, the worktable may include more than two tabletops. As described in more detail below, the tabletops are modularly designed to enable two, three, or four or more tabletops to be secured together to increase the worksurface provided by the worktable.

Leg

With reference to FIGS. 1, 4 and 5, leg 104 supports worktable 103 from the ground.

In the present example, leg 104 is a tubular member was a base configured to be bolted to the ground, if desired. In some examples, the leg includes casters coupled to the base or in place of the base. As shown in FIGS. 1-6, leg 104 defines shaped openings that are configured the same as the shaped openings 108.

The leg may be any currently known or later developed type of leg. The reader will appreciate that a variety of leg types exist and could be used in place of the leg shown in the figures. In addition to the types of legs existing currently, it is contemplated that the workpiece securement systems described herein could incorporate new types of legs developed in the future.

The size of the leg may be varied as needed for a given application. In some examples, the leg is larger relative to the other components than depicted in the figures. In other examples, the leg is smaller relative to the other components than depicted in the figures. Further, the reader should understand that the leg and the other components may all be larger or smaller than described herein while maintaining their relative proportions.

In the example shown in FIGS. 1-9, worktable 103 includes four legs. However, the number of legs in the workpiece securement system may be selected to meet the needs of a given application. The reader should understand that the number of legs may be different in other examples than is shown in the figures. For instance, some workpiece securement system examples include additional or fewer legs than described in the present example.

In the present example, leg 104 is composed of steel. However, the leg may be composed of any currently known or later developed material suitable for the applications described herein for which it is used. Suitable materials include metals, polymers, ceramics, wood, and composite materials.

The shape of the leg may be adapted to be different than the specific examples shown in the figures to suit a given application. For example, the leg may include a face having the shape of a regular or irregular polygon, such as a circle, oval, triangle, square, rectangle pentagon, and the like. Additionally or alternatively, the leg may include a face having an irregular shape. In three dimensions, the shape of the leg may be a sphere, a pyramid, a cone, a cube, and variations thereof, such as a hemisphere or a frustoconical shape.

Tabletop

The role of tabletop 105 and second tabletop 132 is to provide a worksurface for working on workpieces. More particularly, tabletop 105 and second tabletop 132 cooperate with other components of system 100 to secure work-pieces in desired positions.

In the example shown in FIGS. 1-9, worktable 103 includes two tabletops, tabletop 105 and second tabletop 132. The reader can see in FIGS. 1-9 and in FIG. 10 as well that the tabletops are modularly designed to enable additional tabletops to be added to the worktable as needed. In some examples the worktable includes a single tabletop. In other examples, the worktable includes two tabletops, such as shown in FIGS. 1-9, three tabletops, four tabletops as shown in FIG. 10, or more than four tabletops.

The reader can see in FIGS. 1-4 and 6 that second tabletop 132 is coupled to tabletop 105 along lateral edge 133 of tabletop 105. Lateral edge 133 defines a boundary opening 137.

Given the modular nature of the tabletops, the discussion below will primarily describe tabletop 105 in detail. The reader should recognize that second tabletop 132 and any additional modular tabletops may be configured similarly or identically. As depicted in FIGS. 1-6, second tabletop 132 is configured the same as tabletop 105 in the present example.

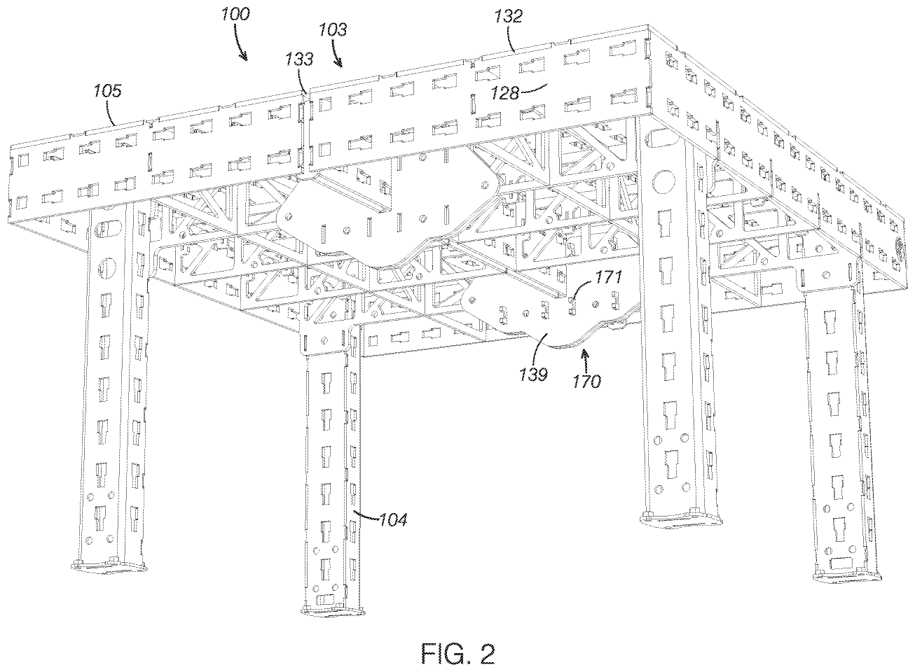

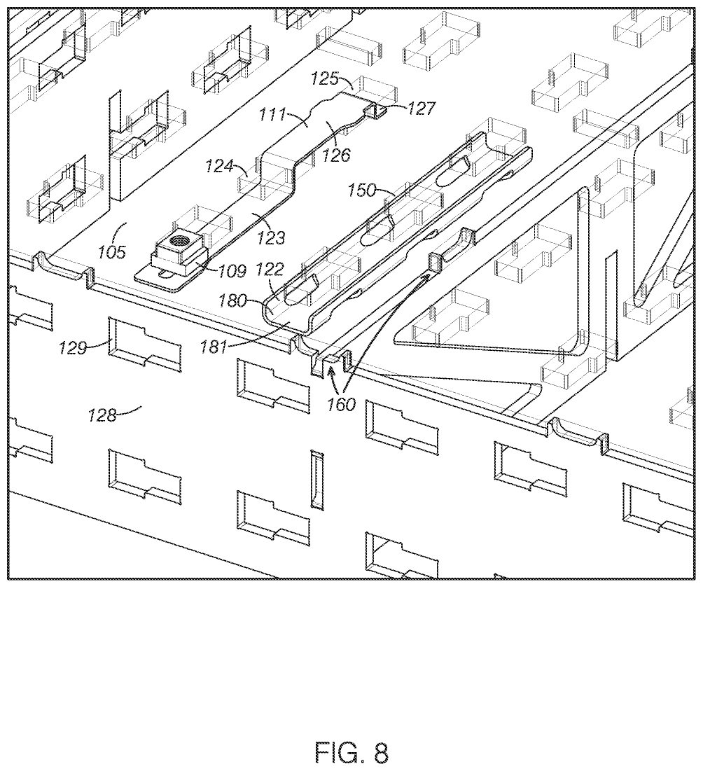

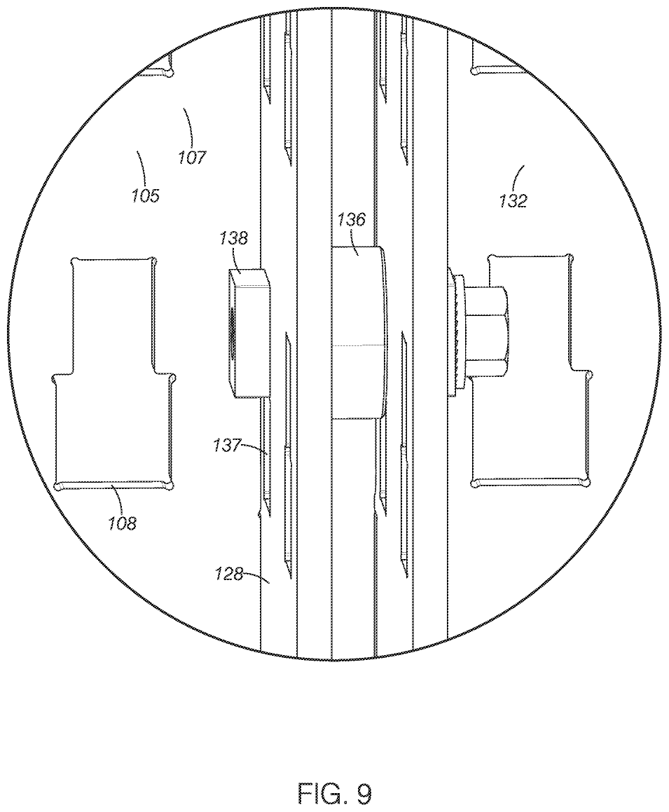

The tabletops are configured to secure together to increase the worksurface provided by the worktable. Tabletop 105 and second tabletop 132 are welded together at defined interlock locations 160 shown in FIG. 8. Additionally, but optionally, FIG. 9 depicts the tabletops secured together with a bolt coupled to a boundary anchor 138 disposed in a boundary opening 137 of tabletop 105. With further reference to FIG. 9, the reader can see a spacer 136 disposed between tabletop 105 and second tabletop 132 to define the spacing between them. FIGS. 2, and 4-6 depict bridge bracket 139 reinforcing and providing rigidity to the union of tabletop 105 and second tabletop 132.

With reference to FIGS. 1-6, tabletop 105 is supported by legs 104. Tabletop 105 includes a top surface 106 facing away from the ground and a bottom surface 107 facing the ground. As can be seen in FIGS. 1-9, tabletop 105 defines a plurality of shaped openings 108 extending through tabletop 105 from top surface 106 to bottom surface 107.

In the present example, the tabletops are each 24 inches wide. However, the size of the tabletop may be varied as needed for a given application. In some examples, the tabletop is larger relative to the other components than depicted in the figures. In other examples, the tabletop is smaller relative to the other components than depicted in the figures. Further, the reader should understand that the tabletop and the other components may all be larger or smaller than described herein while maintaining their relative proportions.

In the present example, tabletop 105 is composed of steel. However, the tabletop may be composed of any currently known or later developed material suitable for the applications described herein for which it is used. Suitable materials include metals, polymers, ceramics, wood, and composite materials.

The shape of the tabletop may be adapted to be different than the specific examples shown in the figures to suit a given application. For example, the tabletop may include a face having the shape of a regular or irregular polygon, such as a circle, oval, triangle, square, rectangle pentagon, and the like. Additionally or alternatively, the tabletop may include a face having an irregular shape.

Shaped Openings

The shaped openings receive components of workpiece securement system 100, such as anchor 109 and shelf 111, and help secure those components in position.

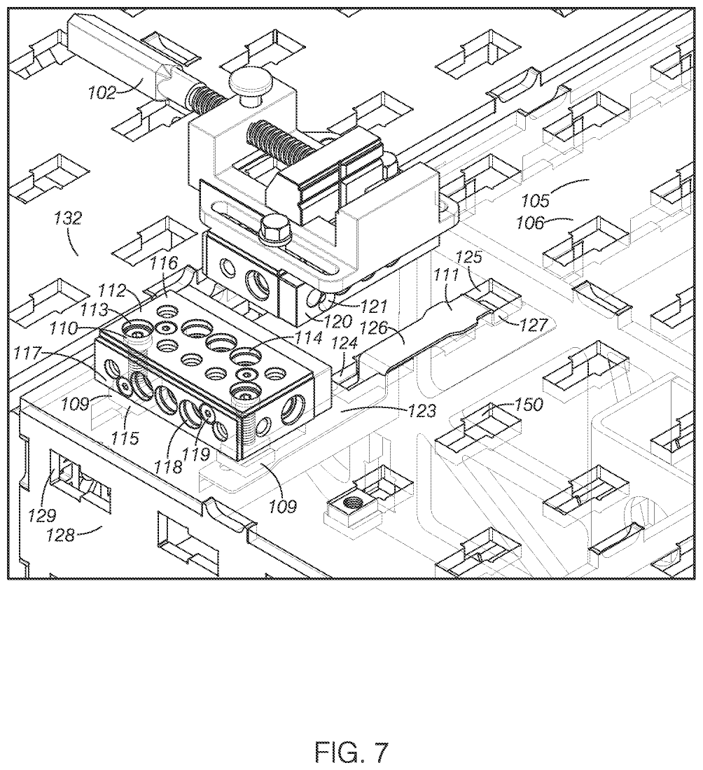

As shown in FIGS. 7 and 8, the shaped openings complement the shape of anchor 109 to restrict anchor 109 from rotating about a vertical axis when disposed within a shaped opening. The reader can see in FIGS. 1-3 and 6-8 that the shaped openings define radius reliefs to facilitate forming the shaped openings utilizing CNC manufacturing techniques. However, the shape of the openings may be adapted to be different than the specific examples shown in the figures to suit a given application.

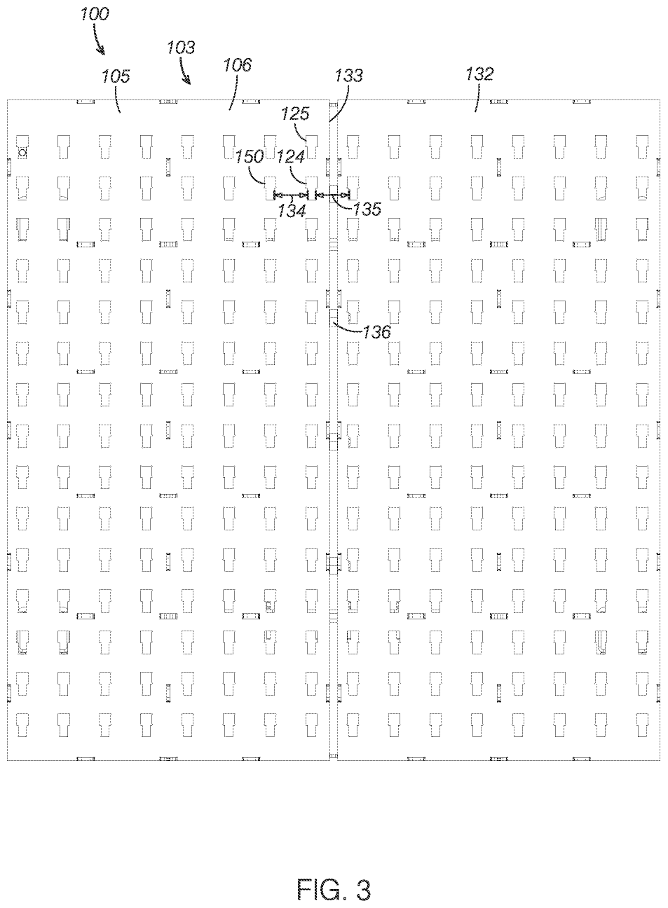

The reader can see in FIGS. 3, 7, and 8 that a first shaped opening 124 is longitudinally adjacent to a second shaped opening 125. As depicted in FIGS. 3, 7 and 8, first shaped opening 124 is laterally adjacent to a third shaped opening 150.

As depicted in FIG. 3, the lateral spacing between laterally adjacent shaped openings on tabletop 105 defines a common spacing dimension 134. The reader can see in FIG. 3 that the lateral spacing between shaped openings of tabletop 105 proximate lateral edge 133 of tabletop 105 and shaped openings of second tabletop 132 proximate lateral edge 133 of tabletop 105 defines an adjacent spacing dimension 135. In the example shown in FIGS. 1-9, adjacent spacing dimension 135 equals common spacing dimension 134 for uniformity and conceptual seamlessness between modular tabletops. However, the adjacent spacing dimension and the common spacing dimension may be different in some examples.

The size of the shaped openings may be varied as needed for a given application. In some examples, the shaped openings are larger relative to the other components than depicted in the figures. In other examples, the shaped openings are smaller relative to the other components than depicted in the figures. Further, the reader should understand that the shaped openings and the other components may all be larger or smaller than described herein while maintaining their relative proportions.

In the present example, tabletop 105 defines a plurality of shaped openings 108. The number of shaped openings in the workpiece securement system may be selected to meet the needs of a given application. The reader should understand that the number of shaped openings may be different in other examples than is shown in the figures. For instance, some workpiece securement system examples include additional or fewer shaped openings than described in the present example.

Spacer

Spacer 136 functions to establish adjacent spacing dimension 135 between tabletop 105 and second tabletop 132. As shown in FIGS. 3, 6 and 9, spacer 136 is configured to mount to lateral edge 133 of tabletop 105 between tabletop 105 and second tabletop 132.

In the present example, spacer 136 is a hexagonal nut. However, the shape of the spacer may be adapted to be different than the specific examples shown in the figures to suit a given application. For example, the spacer may include a face having the shape of a regular or irregular polygon, such as a circle, oval, triangle, square, rectangle pentagon, and the like. Additionally or alternatively, the spacer may include a face having an irregular shape. In three dimensions, the shape of the spacer may be a sphere, a pyramid, a cone, a cube, and variations thereof, such as a hemisphere or a frustoconical shape.

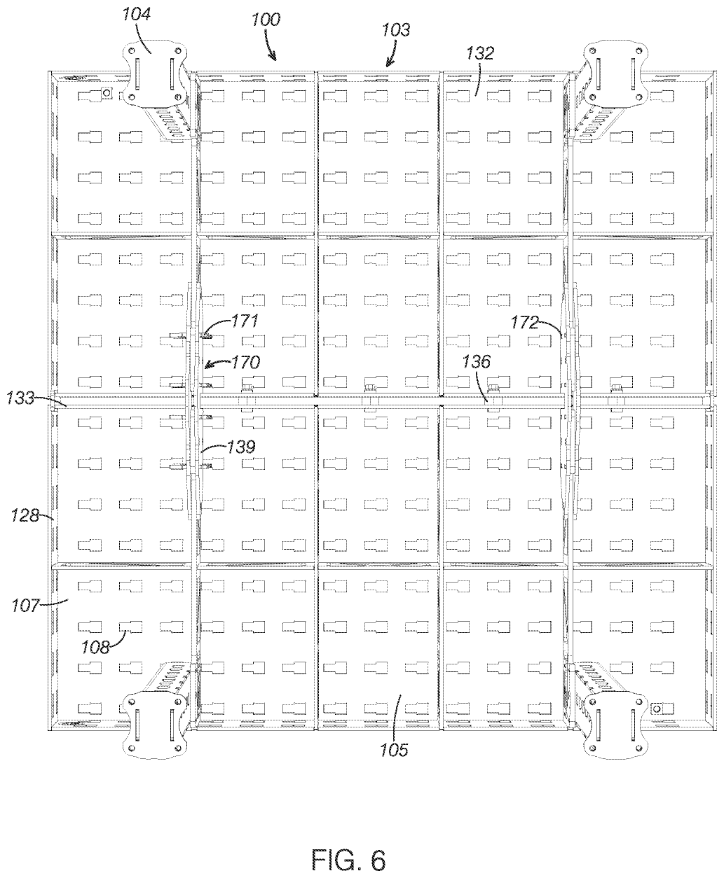

As shown in FIGS. 3 and 6, workpiece securement system 100 includes four spacers. However, the number of spacers in the workpiece securement system may be selected to meet the needs of a given application. The reader should understand that the number of spacers may be different in other examples than is shown in the figures. For instance, some workpiece securement system examples include additional or fewer spacers than described in the present example.

In the example shown in FIGS. 1-9, spacer 136 is selected to provide a desired adjacent spacing dimension 135 between tabletop 105 and second tabletop 132. However, the size of the spacer may be varied as needed for a given application. In some example, the spacer is larger relative to the other components than depicted in the figures. In other example, the spacer is smaller relative to the other component than depicted in the figures. Further, the reader should understand that the spacer and the other component may all be larger or smaller than described herein while maintaining their relative proportions.

The spacer may be any currently known or later developed type of spacer. The reader will appreciate that a variety of spacer types exist and could be used in place of the spacer shown in the figures. In addition to the types of spacers existing currently, it is contemplated that the workpiece securement systems described herein could incorporate new tees of spacers developed in the future.

In the present example, spacer 136 is composed of metal. However, the spacer may be composed of any currently known or later developed material suitable for the applications described herein for which it is used. Suitable materials include metals, polymers, ceramics, wood, and composite materials.

Boundary Anchor

As depicted in FIG. 9, boundary anchor 138 is selectively coupled to spacer 136 to support spacer 136 between tabletop 105 and second tabletop 132. The reader can see in FIG. 9 that boundary anchor 138 is complementarily configured with boundary opening 137 and is disposed in boundary opening 137.

Another function of boundary anchor 138 is to selectively secure block 112 to skirt 128 when disposed in a selected skirt shaped opening 129. Securing block 112 to skirt 128 extends the worksurface of tabletop 105 by having block 112 extend beyond the periphery of tabletop 105. By mounting blocks to skirt 128, the user can secure clamps to blocks in positions beyond the periphery of tabletop 105 when needed.

In the present example, boundary anchor 138 is composed of metal. However, the boundary anchor may be composed of any currently known or later developed material suitable for the applications described herein for which it is used. Suitable materials include metals, polymers, ceramics, wood, and composite materials.

In the present example, workpiece securement system 100 includes four boundary anchors. However, the number of boundary anchors in the workpiece securement system may be selected to meet the needs of a given application. The reader should understand that the number of boundary anchors may be different in other examples than is shown in the figures. For instance, some workpiece securement system examples include additional or fewer boundary anchors than described in the present example.

The shape of the boundary anchor may be adapted to be different than the specific examples shown in the figures to suit a given application. For example, the boundary anchor may include a face having the shape of a regular or irregular polygon, such as a circle, oval, triangle, square, rectangle pentagon, and the like. Additionally or alternatively, the boundary anchor may include a face having an irregular shape. In three dimensions, the shape of the boundary anchor may be a sphere, a pyramid, a cone, a cube, and variations thereof, such as a hemisphere or a frustoconical shape.

The size of the boundary anchor may be varied as needed for a given application. In some examples, the boundary anchor is larger relative to the other components than depicted in the figures. In other examples, the boundary anchor is smaller relative to the other components than depicted in the figures. Further, the reader should understand that the boundary anchor and the other components may all be larger or smaller than described herein while maintaining their relative proportions.

Bridge Bracket

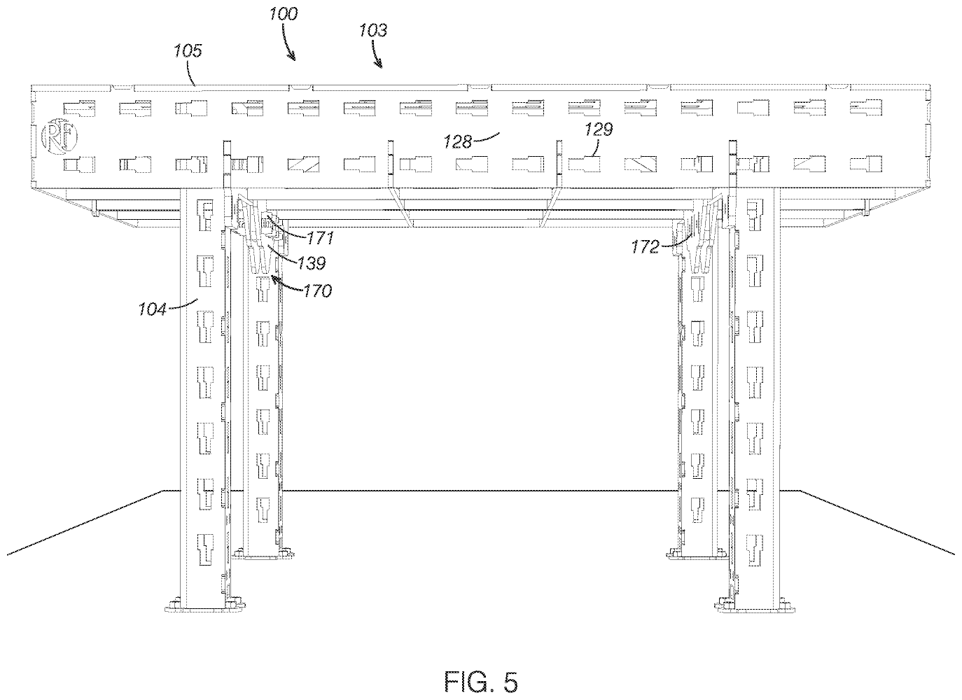

As depicted in FIGS. 2 and 4-6, bridge bracket 139 couples tabletop 105 to second tabletop 132 and structurally reinforces the coupling. Bridge bracket 139 couples to tabletop 105 proximate bottom surface 107 and to second tabletop 132. As shown perhaps most clearly in FIGS. 2 and 5, bridge brackets 139 are organized into bracket pairs 170 comprised of two bridge brackets 139 coupled together with tie members 171 extending through slots 172 defined in bridge brackets 139.

In the present example, workpiece securement system 100 includes four bridge brackets. However, the number of boundary anchors in the workpiece securement system may be selected to meet the needs of a given application. The reader should understand that the number of boundary anchors may be different in other examples than is shown in the figures. For instance, some workpiece securement system examples include additional or fewer boundary anchors than described in the present example.

In the present example, bridge brackets 139 are composed of metal. However, the bridge brackets may be composed of any currently known or later developed material suitable for the applications described herein for which it is used. Suitable materials include metals, polymers, ceramics, wood, and composite materials.

The shape of the bridge brackets may be adapted to be different than the specific examples shown in the figures to suit a given application. Further, the size of the bridge brackets may be varied as needed for a given application. In some examples, the bridge brackets is larger relative to the other components than depicted in the figures. In other examples, the bridge brackets is smaller relative to the other components than depicted in the figures. Further, the reader should understand that the bridge brackets and the other components may all be larger or smaller than described herein while maintaining their relative proportions.

Skirt

Skirt 128 functions to provide a vertical surface with which to mount accessory items, such as a bin. The vertical surface of skirt 128 additionally or alternatively functions to couple together modular tabletops.

With reference to FIGS. 1-8, skirt 128 extends transversely from tabletop 105 toward the ground. As shown in FIGS. 1-8, skirt 128 defines a plurality of skirt shaped openings 129.

In the present example, skirt 128 is composed of metal. However, the skirt may be composed of any currently known or later developed material suitable for the applications described herein for which it is used. Suitable materials include metals, polymers, ceramics, wood, and composite materials.

The size of the skirt may be varied as needed for a given application. In some examples, the skirt is larger relative to the other components than depicted in the figures. In other examples, the skirt is smaller relative to the other components than depicted in the figures. Further, the reader should understand that the skirt and the other components may all be larger or smaller than described herein while maintaining their relative proportions.

Skirt Shaped Openings

Skirt shaped openings 129 serve to receive components of workpiece securement system 100, such as boundary anchor 138, and help secure those components in position.

The reader can see in FIGS. 1-8 that skirt shaped openings 129 are the same size and shape as shaped openings 108 for consistency and uniformity. However, the skirt shaped openings may be different sizes or shapes than the shaped openings in other examples.

The size of the skirt shaped openings may be varied as needed for a given application. In some examples, the skirt shaped openings are larger relative to the other components than depicted in the figures. In other examples, the skirt shaped openings are smaller relative to the other components than depicted in the figures. Further, the reader should understand that the skirt shaped openings and the other components may all be larger or smaller than described herein while maintaining their relative proportions.

The number of skirt shaped openings in the workpiece securement system may be selected to meet the needs of a given application. The reader should understand that the number of skirt shaped openings may be different in other examples than is shown in the figures. For instance, some workpiece securement system examples include additional or fewer skirt shaped openings than described in the present example.

Anchor

Anchor 109 serves to retain blocks 112 in a desired position on worktable 103. As shown in FIGS. 7 and 8, anchor 109 is disposed in a selected shaped opening of plurality of shaped openings 108 and is configured to threadingly engage a bolt 110. Anchor 109 is configured to not rotate within shaped opening 108 despite torque being applied to bolt 110. Anchor 109 laterally abutting the edges of shaped opening 108 restricts anchor 109 from rotating in response to applied torque. As depicted in FIGS. 7 and 8, anchor 109 is supported on floor 123 of shelf 111.

The reader can see in FIGS. 7 and 8 that anchor 109 defines a tee slot nut 115. In other examples, the anchor is configured differently than a tee slot nut.

Anchor 109 being disposed below the surface of tabletop 105 conceals the mounting hardware from view above the tabletop. This provides a cleaner worksurface and protects the mounting hardware from weld splatter.

The shape of the anchor may be adapted to be different than the specific examples shown in the figures to suit a given application. In many, but not necessary all examples, the size and shape of the anchor will complement the size and shape of the shaped openings.

The size of the anchor may be varied as needed for a given application. In some examples, the anchor is larger relative to the other components than depicted in the figures. In other examples, the anchor is smaller relative to the other components than depicted in the figures. Further, the reader should understand that the anchor and the other components may all be larger or smaller than described herein while maintaining their relative proportions.

The number of anchors in the workpiece securement system may be selected to meet the needs of a given application. The reader should understand that the number of anchors may be different in other examples than is shown in the figures. For instance, some workpiece securement system examples include additional or fewer anchors than described in the present example.

In the present example, anchor 109 is composed of metal. However, the anchor may be composed of any currently known or later developed material suitable for the applications described herein for which it is used. Suitable materials include metals, polymers, ceramics, wood, and composite materials.

Bolt

The role of bolt 110 is to selectively couple block 112 to anchor 109 by passing through mount bore 113 of block 112. The bolt may be any currently known or later developed type of bolt. The reader will appreciate that a variety of bolt types exist and could be used in place of the bolt shown in the figures. In addition to the types of bolts existing currently, it is contemplated that the workpiece securement systems described herein could incorporate new type of bolts developed in the future.

The size of the bolt may be varied as needed fora given application. In some examples, the bolt is larger relative to the other components than depicted in the figures. In other examples, the bolt is smaller relative to the other components than depicted in the figures. Further, the reader should understand that the bolt and the other components may all be larger or smaller than described herein while maintaining their relative proportions.

The number of bolts in the workpiece securement system may be selected to meet the needs of a given application. The reader should understand that the number of bolts may be different in other examples than is shown in the figures. For instance, some workpiece securement system examples include additional or fewer bolts than described in the present example.

Shelf

Shelf 111 and shelf 180 function to support anchor 109 from below bottom surface 107 of tabletop 105 in a position where anchor 109 extends through the selected shaped opening. With reference to FIGS. 7 and 8, shelf 111 and shelf 180 are configured to selectively mount to tabletop 105 in a desired position. Two shelf embodiments are depicted in FIG. 8: shelf 111 that selectively inserts into two shaped openings and shelf 180 that is fastened to bottom surface 107.

The reader can see in FIGS. 7 and 8 that shelf 111 selectively inserts into a first shaped opening 124 and a second shaped opening 125. Shelf 111 is configured to insert into two longitudinally aligned shaped openings, such as first shaped opening 124 and second shaped opening 125 depicted in FIG. 8, or in laterally aligned shaped openings, such as first shaped opening 124 and third shaped opening 150. As depicted in FIGS. 7 and 8, shelf 111 includes a floor 123, a bridge 126, and a tab 127.

As depicted in FIGS. 7 and 8, bridge 126 extends from floor 123 above top surface 106 of tabletop 105 between first shaped opening 124 and second shaped opening 125. The length of bridge 126 (and/or the spacing between the vertical members of bridge 126) is selected to match the longitudinal spacing of longitudinally adjacent shaped openings and the lateral spacing of laterally adjacent shaped openings. The lateral spacing of laterally adjacent shaped openings is selected to be the same as the longitudinal spacing of longitudinally adjacent shaped openings to allow shelf 111 to selectively insert into two longitudinally or laterally adjacent shaped openings.

The reader can see in FIGS. 7 and 8 that floor 123 is disposed below bottom surface 107 of tabletop 105 proximate first shaped opening 124 and is configured to support anchor 109. With reference to FIGS. 7 and 8, tab 127 extends below bottom surface 107 of tabletop 105 proximate second shaped opening 125.

Shifting attention to shelf 180, which is configured differently than shelf 111, the reader can see in FIG. 8 that shelf 180 includes a floor 181 and two lateral sidewalls 122 to define a channel in which anchor 109 rests. As shown in FIG. 8, floor 181 extends laterally from sidewalls 122 in a position spaced from bottom surface 107 of tabletop 105. With reference to FIG. 8, sidewalls 122 extend longitudinally along shelf 180.

The upper ends of sidewalls 122 are welded to bottom surface 107 to fix the position of shelf 180. In other examples, the shelf is fastened to the bottom surface by mechanical fasteners, adhesives, or magnetic couplers.

The number of shelves in the workpiece securement system may be selected to meet the needs of a given application. The reader should understand that the number of shelves may be different in other examples than is shown in the figures. For instance, some workpiece securement system examples include additional or fewer shelves than described in the present example.

The shape of the shelf may be adapted to be different than the specific examples shown in the figures to suit a given application. For example, the shelf may include a face having the shape of a regular or irregular polygon, such as a circle, oval, triangle, square, rectangle pentagon, and the like. Additionally or alternatively, the shelf may include a face having an irregular shape. In three dimensions, the shape of the shelf may be a sphere, a pyramid, a cone, a cube, and variations thereof, such as a hemisphere or a frustoconical shape.

The size of the shelf may be varied as needed for a given application. In some examples, the shelf is larger relative to the other components than depicted in the figures. In other examples, the shelf is smaller relative to the other components than depicted in the figures. Further, the reader should understand that the shelf and the other components may all be larger or smaller than described herein while maintaining their relative proportions.

In the present example, shelf 111 and shelf 180 are composed of metal. However, the shelf may be composed of any currently known or later developed material suitable for the applications described herein for which it is used. Suitable materials include metals, polymers, ceramics, wood, and composite materials.

Block

Block 112 serves as a mounting point for clamp 102 to secure workpiece 101 in a desired position. As shown in FIGS. 7 and 8, block 112 is supported on top surface 106 of tabletop 105 and secured in a selected position on tabletop 105 by selectively coupling with anchor 109.

The reader can see in FIGS. 7 and 8 that block 112 defines a first outer face 116 and a second outer face 117. As shown in FIGS. 7 and 8, first outer face 116 faces away from the ground when block 112 is supported on top surface 106 of tabletop 105. The reader can see in FIGS. 7 and 8 that second outer face 117 is oriented perpendicular to the ground when block 112 is supported on top surface 106 of tabletop 105.

With reference to FIGS. 7 and 8, block 112 defines a mount bore 113 and a clamp receiver bore 114 in first outer face 116, and a second clamp receiver bore 118 in second outer face 117. As depicted in FIGS. 7 and 8, second outer face 117 defines block coupler bore 119.

In the present example, block 112 is composed of metal. However, the block may be composed of any currently known or later developed material suitable for the applications described herein for which it is used. Suitable materials include metals, polymers, ceramics, wood, and composite materials.

The size of the block may be varied as needed for a given application. In some examples, the block is larger relative to the other components than depicted in the figures. In other examples, the block is smaller relative to the other component than depicted in the figures. Further, the reader should understand that the block and the other components may all be larger or smaller than described herein while maintaining their relative proportions.

In the present example, the blocks are precision milled and configured to be installed in multiple orientations, stacked and couple with flush mount shims to create 90-degree ledges and varying plane heights for fixturing. The block may be any currently known or later developed type of block. The reader will appreciate that a variety of block types exist and could be used in place of the block shown in the figures. In addition to the types of blocks existing currently, it is contemplated that the workpiece securement systems described herein could incorporate new types of blocks developed in the future.

The number of blocks in the workpiece securement system may be selected to meet the needs of a given application. The reader should understand that the number of blocks may be different in other examples than is shown in the figures. For instance, some workpiece securement system examples include additional or fewer blocks than described in the present example.

Mount Bore

The role of mount bore 113 is to cooperate with bolt 110 to mount block 110 to tabletop 105. With reference to FIGS. 7 and 8, mount bore 113 extends through block 112 and is aligned with anchor 109. Bolt 110 passing through mount bore 113 and threadingly engaging anchor 109 secures the position of block 112 on top surface 106 of tabletop 105.

As shown in FIGS. 7 and 8, mount bore 113 is defined in first outer face 116. The reader can see in FIGS. 7 and 8 that mount bore 113 is countersunk relative to first outer face 116 to receive bolt 110 in a recessed position relative to first outer face 116.

The number of mount bores in the workpiece securement system may be selected to meet the needs of a given application. The reader should understand that the number of mount bores may be different in other examples than is shown in the figures. For instance, some workpiece securement system examples include additional or fewer mount bores than described in the present example.

Clamp Receiver Bore

Clamp receiver bore 114 functions to cooperate with a bolt of clamp 102 to couple clamp 102 to block 112. As depicted in FIGS. 7 and 8, clamp receiver bore 114 is configured to receive clamp 102 to fix the position of workpiece 101. With reference to FIGS. 7 and 8, clamp receiver bore 114 is defined in first outer face 116.

The number of clamp receiver bores in the workpiece securement system may be selected to meet the needs of a given application. The reader should understand that the number of clamp receiver bores may be different in other examples than is shown in the figures. For instance, some workpiece securement system examples include additional or fewer clamp receiver bores than described in the present example.

Block Coupler Bore

Block coupler bore 119 cooperates with a bolt and a shim coupler bore 121 to selectively couple shim 120 to block 112. As depicted in FIGS. 7 and 8, block coupler bore 119 is defined in second outer face 117.

Shim

Shim 120 functions to laterally extend the clamping coupling region from block 112. Shim accommodates securing clamp 102 to a position laterally extended from block 112 when it would be helpful to clamp a workpiece in a position laterally beyond the reach of clamp receiver bores 114 defined in block 112. In the present examples, the shims mount flush to the blocks to create 90-degree ledges and varying plane heights for fixturing.

As shown in FIG. 7, shim 120 is coupled to second outer face 117 of block 112. Shim 120 defines a shim coupler bore 121 complementarily configured and aligned with block coupler bore 119.

The size of the shim may be varied as needed for a given application. In some examples, the shim is larger relative to the other components than depicted in the figures. In other examples, the shim is smaller relative to the other components than depicted in the figures. Further, the reader should understand that the shim and the other components may all be larger or smaller than described herein while maintaining their relative proportions.

In the present example, shim 120 is composed of metal. However, the shim may be composed of any currently known or later developed material suitable for the applications described herein for which it is used. Suitable materials include metals, polymers, ceramics, wood, and composite materials.

The shape of the shim may be adapted to be different than the specific examples shown in the figures to suit a given application. For example, the shun may include a face having the shape of a regular or irregular polygon, such as a circle, oval, triangle, square, rectangle pentagon, and the like. Additionally or alternatively, the shim may include a face having an irregular shape. In three dimensions, the shape of the shim may be a sphere, a pyramid, a cone, a cube, and variations thereof, such as a hemisphere or a frustoconical shape.

The shim may be any currently known or later developed type of shim. The reader will appreciate that a variety of shim types exist and could be used in place of the shim shown in the figures. In addition to the types of shims existing currently, it is contemplated that the workpiece securement systems described herein could incorporate new types of shims developed in the future.

The number of shims in the workpiece securement system may be selected to meet the needs of a given application. The reader should understand that the number of shims may be different in other examples than is shown in the figures. For instance, some workpiece securement system examples include additional or fewer shims than described in the present example.

### Additional Embodiments

With reference to FIG. 10, the discussion will now focus on a second workpiece securement system embodiment. The additional embodiment includes many similar or identical features to workpiece securement system 100. Thus, for the sake of brevity, each feature of the additional embodiment below will not be redundantly explained. Rather, key distinctions between the additional embodiment and workpiece securement system 100 will be described in detail and the reader should reference the discussion above for features substantially similar between the different system examples.

### Second Embodiment

Turning attention to FIG. 10, workpiece securement system 200 will now be described as a second example of a workpiece securement system. In FIG. 10, workpiece securement system 200 includes a worktable 203, an anchor, a shelf, a block 212, a shim 220, a bin 230, an electrical system 240, and an illumination device 245.

A distinction between workpiece securement system 200 and workpiece securement system 100 is that worktable 203 includes four tabletops instead of two as with worktable 103. Of note, worktable 203 includes the same number of legs, four, as worktable 103.

Additional distinctions between system 200 and system 100 result from the additional features that system 200 includes. The additional features are described below.

Bin

The role of bin 230 is to store items in a convenient location for a user to access while using workpiece securement system 200. With reference to FIG. 10, the reader can see that bin 230 is mounted to skirt 228.

Bin 230 defines a bin mount bore complementarily is configured with a bolt used to selectively couple bin 230 to an anchor coupled to skirt 228. In FIG. 10, an anchor is positioned in a desired skirt shaped opening to provide a mounting point for bin 230. Bin 230 mounts to skirt 228 by passing the bolt through the bin mount bore of bin 230 and threadingly engaging the bolt with the anchor in the desired skirt shaped opening.

In the present example, bin 230 is composed of metal. However, the bin may be composed of any currently known or later developed material suitable for the applications described herein for which it is used. Suitable materials include metals, polymers, ceramics, wood, and composite materials.

The number of bins in the workpiece securement system may be selected to meet the needs of a given application. The reader should understand that the number of bins may be different in other examples than is shown in the figures. For instance, some workpiece securement system examples include additional or fewer bins than described in the present example.

The shape of the bin may be adapted to be different than the specific examples shown in the figures to suit a given application. Some bin examples have more or fewer compartments while certain bin examples have a single compartment.

The size of the bin may be varied as needed for a given application. In some examples, the bin is larger relative to the other components than depicted in the figures. In other examples, the bin is smaller relative to the other components than depicted in the figures. Further, the reader should understand that the bin and the other components may all be larger or smaller than described herein while maintaining their relative proportions.

The bin may be any currently known or later developed type of bin. The reader will appreciate that a variety of bin types exist and could be used in place of the bin shown in the figures. In addition to the types of bins existing currently, it is contemplated that the workpiece securement systems described herein could incorporate new types of bins developed in the future.

Electrical System

Electrical system 240 functions to provide a source of power to worktable 203 accessible to a user. As shown in FIG. 10, electrical system 240 is mounted to worktable 203 and electrically isolated from worktable 203. The reader can see in FIG. 10 that electrical system 240 includes a power distribution system 241 and a power socket 242.

Power Distribution System

Power distribution system 241 serves to distribute electrical power to different locations of worktable 203. Power distribution system 241 also electrically couples electrical system 240 with a utility power source. However, in some examples, the electrical system relies on an onboard power source, such as a battery or fuel cell, rather than electrically coupling to a utility power source. In those examples, the power distribution system electrically couples to the onboard power source.

The number of power distribution systems in the workpiece securement system may be selected to meet the needs of a given application. The reader should understand that the number of power distribution systems may be different in other examples than is shown in the figures. For instance, some workpiece securement system examples include additional or fewer power distribution systems than described in the present example.

The power distribution system may be any currently known or later developed type of power distribution system. The reader will appreciate that a variety of power distribution system types exist and could be used in place of the power distribution system shown in the figures. In addition to the types of power distribution systems existing currently, it is contemplated that the workpiece securement systems described herein could incorporate new types of power distribution systems developed in the future.

Power Socket

The role of power socket 242 is to provide a user with access to the electrical power distributed by power distribution system 241. As depicted in FIG. 10, power socket 242 is electrically coupled to power distribution system 241. Power socket 242 enables a power tool 243 to receive power from power distribution system 241 by plugging a power plug 244 into power socket 242. Likewise, illumination device 245 receives power from power distribution system 241 by plugging a power plug 244 into power socket 242.

The power socket may be any currently known or later developed type of power socket. The reader will appreciate that a variety of power socket types exist and could be used in place of the power socket shown in the figures. In addition to the types of power sockets existing currently, it is contemplated that the workpiece securement systems described herein could incorporate new types of power sockets developed in the future.

FIG. 10 depicts four power sockets, but the number of power sockets in the workpiece securement system may be selected to meet the needs of a given application. The reader should understand that the number of power sockets may be different in other examples than is shown in the figures. For instance, some workpiece securement system examples include additional or fewer power sockets than described in the present example.

Power Plug

The power plug may be any currently known or later developed type of power plug. The reader will appreciate that a variety of power plug types exist and could be used in place of the power plug shown in the figures. In addition to the types of power plugs existing currently, it is contemplated that the workpiece securement systems described herein could incorporate new types of power plugs developed in the future.

Power Tool

In the FIG. 10 example, power tool 243 is a grinding tool. However, the power tool may be any currently known or later developed type of power tool. The reader will appreciate that a variety of power tool types exist and could be used in place of the power tool shown in the figures. In addition to the types of power tools existing currently, it is contemplated that the workpiece securement systems described herein could incorporate new types of power tools developed in the future.

Illumination Device

Illumination device 245 functions to illuminate worktable 203. Some system examples include an illumination device positioned to illuminate a bin so that contents stored in the bin are easier to see. As shown in FIG. 10, illumination device 245 is electrically coupled to electrical system 240.

In the FIG. 10 example, illumination device is an adjustable lamp. However, the illumination device may be any currently known or later developed type of illumination device. The reader will appreciate that a variety of illumination device types exist and could be used in place of the illumination device shown in the figures. In addition to the types of illumination devices existing currently, it is contemplated that the workpiece securement systems described herein could incorporate new types of illumination devices developed in the future.

The number of illumination devices in the workpiece securement system may be selected to meet the needs of a given application. The reader should understand that the number of illumination devices may be different in other examples than is shown in the figures. For instance, some workpiece securement system examples include additional or fewer illumination devices than described in the present example.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A workpiece securement system for securing a workpiece in a desired position with a clamp, the workpiece securement system comprising:
a worktable including:
a leg supporting the worktable from the ground; and
a tabletop supported by the leg, the tabletop including a top surface facing away from the ground and a bottom surface facing the ground, the tabletop defining a plurality of shaped openings extending through the tabletop from the top surface to the bottom surface;
an anchor disposed in a selected shaped opening of the plurality of shaped openings and configured to threadingly engage a bolt;
a shelf configured to selectively couple to the tabletop in a desired position and to support the anchor from below the bottom surface of the tabletop in a position where the anchor extends through the selected shaped opening;
a block supported on the top surface of the tabletop and secured in a selected position on the tabletop by selectively coupling with the anchor, the block defining:
a mount bore extending through the block and aligned with the anchor, wherein the bolt passing through the mount bore and threadingly engaging with the anchor secures the position of the block on the top surface of the tabletop;
a clamp receiver bore configured to receive the clamp to fix the position of the workpiece.

2. The workpiece securement system of claim 1, wherein the anchor defines a tee slot nut.

3. The workpiece securement system of claim 1, wherein the shaped opening is complementarily configured with the anchor to restrict the anchor from rotating within the shaped opening.

4. The workpiece securement system of claim 1, wherein the shaped openings define radius reliefs to facilitate forming the shaped openings utilizing CNC manufacturing techniques.

5. The workpiece securement system of claim 1, wherein the block defines:
a first outer face facing away from the ground when the block is supported on the top surface of the tabletop; and
a second outer face oriented perpendicular to the ground when the block is supported on the top surface of the tabletop.

6. The workpiece securement system of claim 5, wherein:
the clamp receiver bore is defined in the first outer face; and
the block defines a second clamp receiver bore defined in the second outer face.

7. The workpiece securement system of claim 5, wherein:
the second outer face defines a block coupler bore; and
the workpiece securement system further comprises a shim coupled to the second outer face of the block, the shim defining a shim coupler bore complementarily configured and aligned with the block coupler bore.

8. The workpiece securement system of claim 5, wherein:
the mount bore is defined in the first outer face; and
the mount bore is countersunk relative to the first outer face to receive the bolt in a recessed position relative to the first outer face.

9. The workpiece securement system of claim 1, wherein the shelf includes:
a sidewall coupled to the bottom surface of the tabletop extending longitudinally along the shelf; and
a floor extending laterally from the sidewall in a position spaced from the bottom surface of the tabletop.

10. The workpiece securement system of claim 9, wherein the anchor is supported on the floor of the shelf.

11. The workpiece securement system of claim 1, wherein:
the plurality of shaped openings include:
a first shaped opening; and
a second shaped opening adjacent to the first shaped opening, and
the shelf selectively insert into the first shaped opening and the second shaped opening.

12. The workpiece securement system of claim 11, wherein the shelf includes:
a floor disposed below the bottom surface of the tabletop proximate the first shaped opening and configured to support the anchor;
a bridge extending from the floor above the top surface of the tabletop between the first shaped opening and the second shaped opening; and
a tab extending below the bottom surface of the tabletop proximate the second shaped opening.

13. The workpiece securement system of claim 12, wherein the first shaped opening is longitudinally adjacent to the second shaped opening.

14. The workpiece securement system of claim 12, wherein the first shaped opening is laterally adjacent to the second shaped opening.

15. The workpiece securement system of claim 1, wherein:
the worktable includes a skirt extending transversely from the tabletop toward the ground; and
the skirt defines a plurality of skirt shaped openings.

16. The workpiece securement system of claim 15, further comprising a bin mounted to the skirt.

17. The workpiece securement system of claim 1, wherein:
the bin defines a bin mount bore complementarily configured with the bolt;
the skirt shaped openings are the same as the shaped openings; and
the bin mounts to the skirt by positioning the anchor in a desired skirt shaped opening and passing the bolt through the bin mount bore and threadingly engaging the bolt with the anchor.

18. The workpiece securement system of claim 1, further comprising a second tabletop coupled to the tabletop along a lateral edge of the tabletop.

19. The workpiece securement system of claim 18, wherein the second tabletop is configured the same as the tabletop.

20. The workpiece securement system of claim 19, wherein:
the lateral spacing between laterally adjacent shaped openings on the tabletop defines a common spacing dimension;
the lateral spacing between shaped openings of the tabletop proximate the lateral edge of the tabletop and shaped openings of the second tabletop proximate the lateral edge of the tabletop defines an adjacent spacing dimension; and
the adjacent spacing dimension equals the common spacing dimension.

21. The workpiece securement system of claim 20, wherein the worktable includes a spacer configured to mount to the lateral edge between the tabletop and the second tabletop to establish the adjacent spacing dimension.

22. The workpiece securement system of claim 21, wherein:
the lateral edge defines a boundary opening;
the worktable includes a boundary anchor complementarily configured with the boundary opening and disposed in the boundary opening; and
the boundary anchor is selectively coupled to the spacer to support the spacer between the tabletop and the second tabletop.

23. The workpiece securement system of claim 21, wherein the worktable includes a bridge bracket coupled to the tabletop proximate the bottom surface and to the second tabletop to couple the tabletop to the second tabletop.

24. The workpiece securement system of claim 1, further comprising an electrical system mounted to the worktable and electrically isolated from the worktable,

25. The workpiece securement system of claim 24, wherein the electrical system includes:
a power distribution system; and
a power socket electrically coupled to the power distribution system to enable a power tool to receive power from the power distribution system by plugging into the power socket with a power plug.

26. The workpiece securement system of claim 24, further comprising an illumination device electrically coupled to the electrical system.
